(19) United States
(12) Patent Application Publication
(10) Pub. No.: US 2014/0130063 A1
(43) Pub. Date: May 8, 2014

(54) SYSTEMS AND METHODS FOR LOW OVERHEAD REMOTE PROCEDURE CALLS

(71) Applicant: CLOUDCAR, INC., Los Altos, CA (US)

(72) Inventor: Peter Barrett, Palo Alto, CA (US)

(73) Assignee: CLOUDCAR, INC., Los Altos, CA (US)

(21) Appl. No.: 13/671,449

(22) Filed: Nov. 7, 2012

(51) Int. Cl. G06F 9/54

(52) U.S. Cl. 719/313

(57) ABSTRACT

A system and method for providing low overhead remote procedure calls are disclosed. A particular embodiment includes: generating, by use of a data processor, a data packet having a command type header portion and a payload portion; branding, by use of the data processor, the data packet with a command type header from the group: an event type, a remote procedure call (RPC) request type, an RPC response type, and an RPC signal type; packing data into the payload portion based on a data representation corresponding to the command type header, if the command type header is an event type; specifying an interface and a method to invoke on a remote system, if the command type header is an RPC request type; and causing the data packet to he transferred to a subsystem via an inter-process data communication.

### TECHNICAL FIELD

This patent document pertains generally to tools (systems, apparatuses, methodologies, computer program products, etc.) for allowing electronic devices to share information with each other, and more particularly, but not by way of limitation, to systems and methods for providing low overhead remote procedure calls.

### BACKGROUND

As a standard construct in many multi-system software designs, a remote procedure call (RPC) is an inter-process communication that allows a computer program to cause a sub-process or procedure to execute in another address space commonly on another computer or computing system on a shared network or data communication bus) without the programmer explicitly coding the details fur this remote interaction. The sub-process or procedure can be a subroutine, function, routine, method, or subprogram, which is typically a part of the software within a larger computer program that performs a specific task and is relatively independent of the remaining code. Using this RPC construct, the programmer can write essentially the same code whether the sub-process or procedure is local to the executing program or remotely located in another computing system. When the software uses object-oriented principles, an RPC can sometimes be called a remote invocation or a remote method invocation.

An RPC is typically initiated by a software system executing in an initiator or requester, which sends as request message to a known remote responder to execute a specified procedure with supplied parameters. The remote responder executes the specified procedure remotely and sends a response back to the requester. The software system in the requester can then continue its processing. There are many variations and subtleties m various RPC implementations, resulting in a variety of different and sometimes incompatible RPC protocols. In many RPC implementations, the requester is blocked (i.e., the requester waits until the responder has finished processing before the software system in the requester can continue execution), unless the requester sends tin asynchronous request to the responder.

Although the RPC mechanism can simplify software design for the programmer, the use of an RPC can introduce system overhead, such as the execution of additional instructions in both the requester and responder, the timing latencies caused by inter-process communication, latencies caused by additional error handling, and the like. As a result, conventional RPC may be used sparingly to avoid the drawbacks of excessive system overhead.

### BRIEF DESCRIPTION OF THE DRAWINGS

The various embodiments is illustrated by way of example, and not by way of limitation, in the figures of the accompanying drawings in which:

FIG. 1 illustrates a block diagram of an example vehicle data abstraction and communication system in which embodiments described herein may be implemented;

FIG. 2 illustrates a detail of a platform system including a cloudcast subsystem in a vehicle information and control system of a particular embodiment;

FIG. 3 illustrates an example of a set of events that can he exposed to the automotive data abstraction and communication system device according to sonic embodiments;

FIG. 4 illustrates an example of the use of the low overhead RPC mechanism for communicating a translation of raw Controller Area Network (CAN) data to corresponding events that can be passed up and processed by higher abstraction layers of a vehicle information and control system;

FIG. 5 illustrates the details of the low overhead RPC mechanism of an example embodiment;

FIG 6 illustrates an example of the data structures and methods or procedures used to service various events mapped from vehicle state change information passed to the subsystems of the vehicle information and control system;

FIG. 7 is a processing flow chart illustrating an example embodiment of a system and method for providing low overhead remote procedure calls as described herein: and

FIG. 8 shows a diagrammatic representation of machine in the example form of a computer system within which a set of instructions when executed may cause the machine to perform any one or More of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

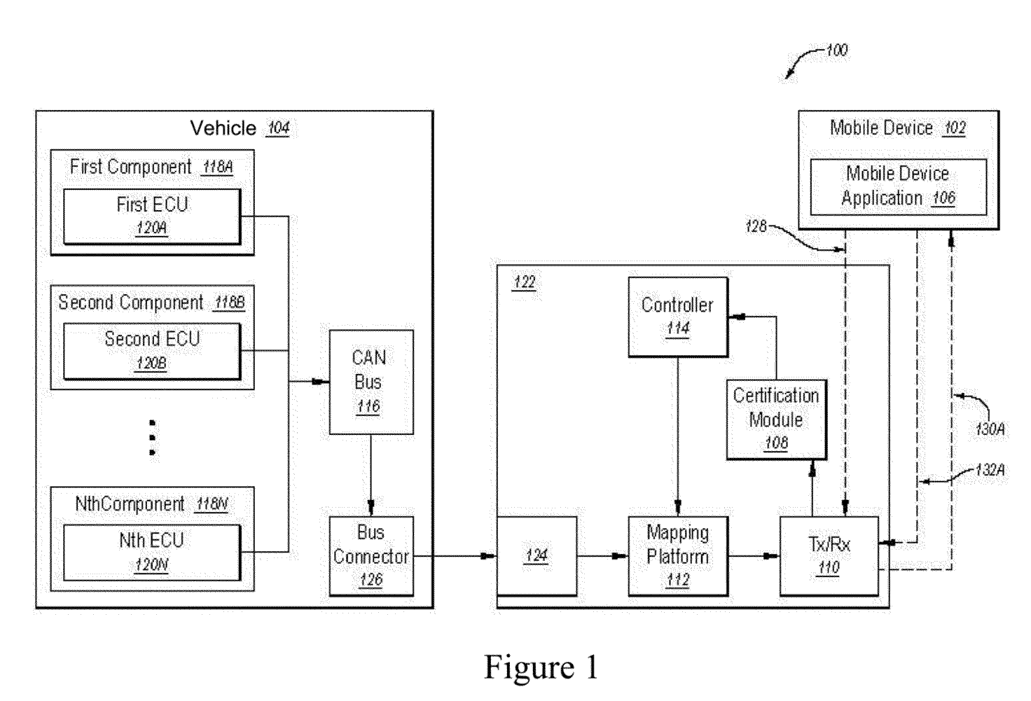

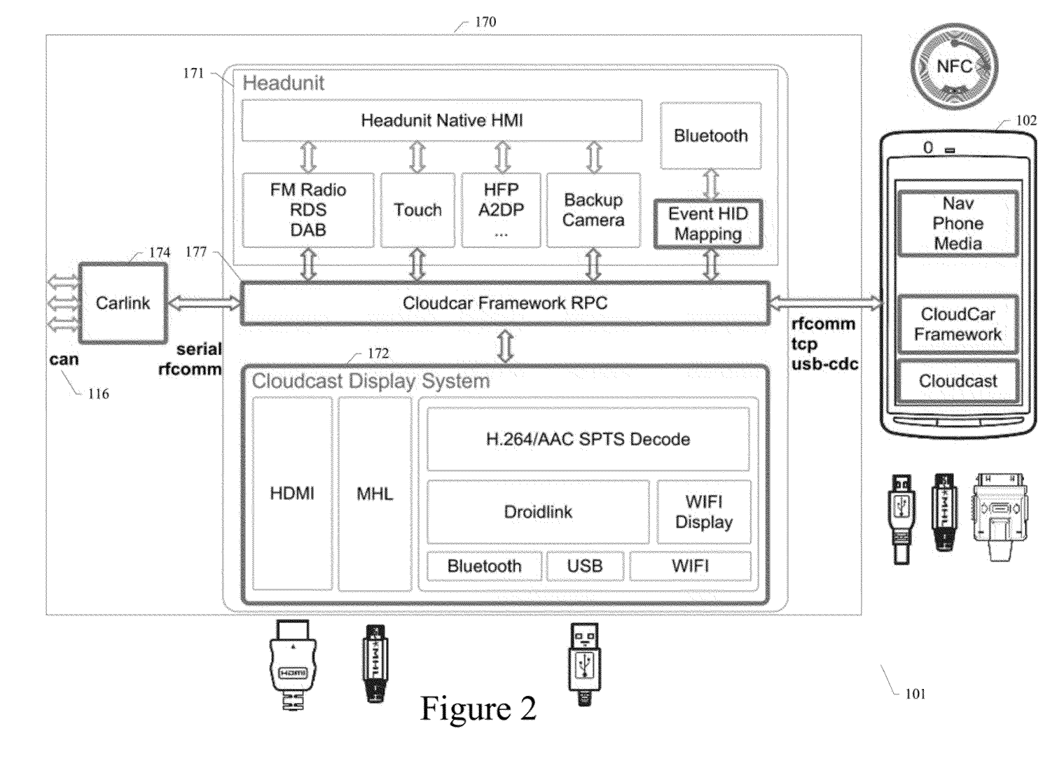

As described in various example embodiments, systems and methods for providing low overhead remote procedure calls are described herein. In one particular embodiment, the use of low overhead remote procedure calls is applied in a vehicle information and control system, such as the system illustrated in FIGS. 1 and 2. However, it will be apparent to those of ordinary skill in the art that the low overhead remote procedure call techniques described and claimed herein can he used in a variety of other applications and systems.

Particular example embodiments relate to the communication of signals and the activation of methods, procedures, or services between mobile devices and Controller Area Network (CAN) buses. Embodiments disclosed herein generally enable the communication of signals between electronic control units (ECUs) of a vehicle, a controller platform, and network-based mobile devices such as mobile phones or mobile computing platforms. Data signals communicated from the ECUs to the mobile device may include information about the state of one or more of the components of the vehicle. In particular, in some embodiments the data signals, which are communicated from the ECUs to the CAN bus, are abstracted by an automotive data abstraction and communication device (abstraction device). The abstraction device connects directly to an On Board Diagnostics (OBD) connector that enables access to the CAN bus. The abstraction device converts the data signals from a vehicle-specific format to a mobile device format defined by an Application Programming Interface (API). The abstraction device then wirelessly and securely transmits the data signals to the mobile device. By converting the data signals to the mobile device format, the mobile device may use the data signals without, knowing the vehicle-specific format. Additionally, the mobile device format defined by the API exposes the data signals. ECUs and other vehicle hardware and software in a standardized way, thereby enabling multiple vendors or software developers to create mobile device applications that process the data signals.

Additionally, a user of the mobile device can send a write or control signal from the mobile device through the abstraction device to the CAN bus. The write/control signal enables the user of the mobile device to alter the state of one or more components included in the vehicle. The write signal is formatted in the mobile device format defined by the API and wirelessly transmitted to the abstraction device. The abstraction device converts the write/control signal to the vehicle-specific format and communicates the write signal to the vehicle. By converting the write signal from the mobile device format defined by the API to the vehicle-specific format, the abstraction device may interlace with multiple vehicles. Additionally, the mobile device format defined by the API acts as a common programming language enabling multiple vendors to write mobile device applications that may communicate read and write signals to multiple types of vehicle independent of model or manufacturer.

As used herein and unless specified otherwise, the term “mobile device” extends to any device that can communicate with the abstraction devices described herein to obtain read or write access to messages or data signals communicated on a CAN bus or via any other mode of inter-process data communications. In many cases, the mobile device is a handheld, portable device, such as a smart phone or a tablet. However, the mobile device can be a computer, diagnostics equipment, a system operated by a vehicle manufacturer or service technician, etc., and is not limited to portable devices.

As used herein, the term “CAN bus,” refers to any bus used in as vehicle for communicating signals between ECUs or components. The CAN bus may be as bus that operates according to versions of the CAN specification, but is not limited thereto. The term “CAN bus” can therefore refer to buses that operate according to other specifications, including those that might he developed in the future.

FIG. 1 illustrates a block diagram of an example vehicle data abstraction and communication system 100 in which embodiments described herein may be implemented. FIG. 1 depicts an example of an operating environment for the vehicle data abstraction and communication systems described herein. FIG. 1 also illustrates an example embodiment in which a mobile device 102 is identified as having an authentication level that permits the mobile device 102 to have access to higher-level events mapped from CAN messages, as opposed to being given direct access to raw CAN messages.

In FIG. 1, the system 100 includes a vehicle 104, an abstraction device 122, a mobile device 102. Generally, FIG. 1 depicts the communication of data signals from the vehicle 104 to the abstraction device 122 and to the mobile device 102. Some of the data signals can be produced at the vehicle 104, the format of the data signals are converted at the abstraction device 122, and the data signals are processed at the mobile device 102.

FIG. 1 depicts a system 100 that includes the vehicle 104. The systems and methods described herein can be used with substantially any mechanized system that uses a CAN bus as defined herein, including, but not limited to, industrial equipment, boats, trucks, or automobiles; thus, the term “vehicle” extends to any such mechanized systems. The systems and methods described herein can also he adapted for use with other devices that have accessible data, such as medical equipment. The systems and methods described herein can also be used with any systems employing sonic form of inter-process data communications.

In a particular embodiment related to a vehicle information and control system, vehicle 104 may include multiple automotive components 118A-118N (generally, a component 118 or components 118). The components 118 include the individual apparatuses, systems, subsystems, mechanisms, etc. that are included in the vehicle 104. The components 118 may include, but are not limited to, windows, door locks, oxygen sensors, an ignition system, windshield wipers, brakes, engines, GPS and navigation systems, a tachometer, etc.

The vehicle 104 may additionally include one or more electronic control units 120A-120N (an ECU 120 or ECUs 120). The ECUs 120 are associated with the components 118. In the particular embodiment shown in FIG. 1, the first ECU 120A associated with the first component 118 may monitor the first component 118. The ECU 120A may communicate a state or a condition of the first component as a data signal to the CAN bus 116. For example, if the first component 118A was the steering wheel, the first ECU 120A may communicate the radial position of the steering wheel in real time to the CAN bus 116. Similarly, the second ECU 120B and the Nth ECU 120N may communicate the data signals to the CAN bus 116 regarding the state or the condition of the second component 118B and the Nth component 120N, respectively. Accordingly, the data signals may include, but are not limited to, positions of the windows, positions of the door locks, oxygen levels measured in the oxygen sensors, ignition timing, state of the windshield wipers, a position of the steering wheel, RPM of the engine, and the like.

The data signals may he formatted in a vehicle-specific format—i.e., specific to a vehicle make and model. The vehicle-specific format generally refers to the format of the data signals for the vehicle 104. That is, the vehicle 104 may be manufactured by a first manufacturer that may have a vehicle-specific format for all its vehicles. Alternatively, the first manufacturer may have a vehicle-specific format for different models, years, option packages, etc. Generally, the vehicle-specific formats of different vehicles 104 are not the same. Thus, a vehicle manufactured by the first manufacturer typically has a different vehicle-specific format that to second vehicle manufactured by as second manufacture. Additionally or alternatively, in some embodiments, the data signals may be differential signals.

The CAN bus 116 receives the data signals from the ECUs 170. Additionally, the CAN bus 116 may enable the components 118 or some subset thereof to internally communicate without an additional computer system. Thus, data signals received at the CAN bus 116 may he available for download, may be internally communicated within the vehicle 104, or may be dropped,

In some embodiments, the CAN bus 116 may be coupled to a bus connector 126 that enables access to the CAN bus 116. For example, in this and other embodiments, the vehicle 104 may include an On Board Diagnostics (OBD) connector. The bus connector may be configured according to an OBD II specification, for instance. In embodiments with multiple CAN buses 116, the vehicle 104 may include multiple bus connectors 126 and/or alternative bus connectors that enable access to one or more CAN buses 116. In most modem vehicles, the CAN bus 116 includes the bus connector 126 located under the hood or accessible through the removal of a panel in the cabin of the vehicle 104. However, embodiments described herein can be implemented by using connector 124 that connects with CAN bus 116 in any available way.

The data signals or sonic subset thereof may be communicated to the abstraction device 122. In some embodiments, the abstraction device 122 is a discrete unit that can be adapted for use with one or more existing or new vehicles 104. For example, as explained herein, the abstraction device 122 can be embodied in a discrete unit that can be installed in an existing or new vehicle 104 by connecting it to the bus connector 126 (e.g., an OBD II connector) associated with CAN bus 116. In this way, the methods and systems described herein can be easily used with substantially any new or existing vehicle 104 that includes a CAN bus 116.

In other embodiments, the abstraction device 122 or elements thereof may be integrated into new vehicles or retrofitted into an existing vehicle. Under this approach, the elements of the abstraction device 122 are a substantially permanent system of vehicle 104, in this case, abstraction device 122 can replace or supplement the bus connector 126 that may otherwise be present in the vehicle 104. In these embodiments, the abstraction device 122 may be a platform within a larger apparatus or system or may he an integrated circuit with controllers and/or microcontrollers that manage or dictate the function of the abstraction device 122.

The abstraction device 122 couples with the bus connector 126 associated with the CAN bus 116 via a connector 124. For example, the CAN bus 116 may have a bus connector 126 (e.g., an OBD II connector) that is adapted to connect with the connector 124 or the abstraction device 122 may include the connector adapted to interface with the bus connector 126. Generally, the interface between the connector 124 and the bus connector 126 includes a physical connection as well as an electrical interface such that the data signals communicated to the CAN bus 116 may be further communicated to the abstraction device 122.

When connected to the CAN bus 116, the connector 124 may communicate the data signals to mapping platform 112. Generally, the mapping platform 112 may he configured to convert a data signal from the vehicle-specific format into a mobile device format defined by an Application Programming Interface (API). Additionally, in some embodiments, the API included in the mapping platform 112 may enable the conversion of data signals from multiple vehicle-specific formats to the mobile device format. Thus, the mapping platform 112 may not he specific to the vehicle 104. Some additional details of the mapping platform 112 and the API are discussed with reference to FIG. 2. Alternatively, in some embodiments, the abstraction device 122 may include one or more controllers 114 that may be configured to receive one or more data signals from the CAN bus 116. The controller 114 may then communicate the data signals to the mapping platform 112.

The transceiver 110 may receive data signals that have been converted to the mobile device format defined by the API. The transceiver 110 may then communicate the data signals formatted in the mobile device format to the mobile device 102.

As described in more detail below, any of the data signals processed by the abstraction device 122 can be communicated using a remote procedure call (RPC) produced by the low overhead RPC mechanism disclosed herein. In many cases, one or multiple RPC's can be used by the abstraction device 122 to communicate the data signals to other subsystems or to the mobile device 102. It will be apparent to those of ordinary skill in the art that any data signals or inter-process processing tasks at any level or layer within the vehicle information and control system 101 can he performed or supported using the low overhead RPC mechanism disclosed herein.

The mobile device 102 may include but is not limited to, a mobile phone, a smartphone, a personal digital assistant, a laptop computer, a tablet computer, or other mobile communication and/or computing device. Accordingly, the mobile device format may include or he configured to operate with any programming format, protocol, or language including, but not limited to, JavaScript, C++, iOS, Android, etc.

The mobile device 102 receives the data signals communicated from the abstraction device 122. In embodiments in which the transceiver 110 wirelessly communicates the data signals to the mobile device 102, the mobile device 102 includes wireless capabilities such as Bluetooth, 3G, 4G, LTE, etc. For example, if the transceiver 110 includes a Bluetooth transceiver, the mobile device 102 includes Bluetooth capabilities. Generally, the mobile device 102 includes one or more mobile device applications 106 that process the data signals. The mobile device application 106 may be loaded or installed on the mobile device 102. Alternatively, the mobile device 102 may access the mobile device application 106 via a network cloud or internet browser, for example. The mobile device application 106 may he written or created to process data signals in the mobile device format rather than the vehicle-specific format. Accordingly, the mobile device application 106 may he vehicle-agnostic. That is, the mobile device application 106 may process data signals from any vehicle 104 once the data signals formatted in the vehicle-specific format are converted by the mapping platform 112.

In some embodiments, the mobile device application 106 includes an ability to perform an API call. The API call is represented in FIG. 1 by arrow 132A. The API call 132A may he an integrated portion of the mobile device application 106 and may allow a user of the mobile device 102 to request data signals from the vehicle 104. The API call 132A may he communicated to the transceiver 110, which then relays the content of the API call 132A through the mapping platform 112, which converts the requested data signals to the mobile device format. The requested data signals are transmitted to the mobile device 102. In other embodiments described in more detail below, a remote procedure call (RPC) can he used to request data or invoke a function using an inter-process communication that allows a mobile device application 106, for example, to cause a sub-process or procedure to execute in as vehicle component 118 or the abstraction device 122.

By processing, the data signals, the mobile device application 106 may function better than a mobile device application without the data signals or may be able to provide functionality not possible without the data signals. For example, the mobile device applications 106 may include as navigation application. The navigation application may receive GPS signals as well as data signals related to a radial position of the steering wheel, an angle of the tires, a speed, etc. of the vehicle 104. The navigation application may process the GPS signals as well as the data signals from the vehicle 104. Thus, the navigation application may output more accurate navigation data than another navigation application that only processes GPS signals. Examples of the mobile device applications 106 are not limited to the above examples. The mobile device application 106 may include any application that processes, abstracts, or evaluates data signals from the vehicle 104 or transmits write/control signals to the vehicle 104.

Referring now to FIG. 2, a detail of a platform system 170 including a cloudcast subsystem 172 in a vehicle information and control system 101 of a particular embodiment is shown. As shown in FIG. 2, the cloudcast subsystem 172 of the platform system 170 can include an HDMI (High-Definition Multimedia Interface) module including a compact HDMI audio/video interface for transferring uncompressed digital audio/video data from an HDMI-compliant device (“the source”) to as compatible digital audio and/or display device in the vehicle. Similarly, the cloudcast subsystem 172 can include a Mobile High-definition Link (MHL) for connecting portable electronic devices to the platform system 170. A variety of other modules or components provided in the cloudcast subsystem 172 can enable the transfer of data and media content to/from the platform system 170 in a variety of modes, protocols, and formats. In an example embodiment, these other modules provided in the cloudcast subsystem 172 can include a Bluetooth (a wireless technology standard for exchanging data over short distances) module, a USB (Universal Serial Bus) module, a WiFi (a popular technology allowing an electronic device to exchange data wirelessly over a computer network) module, a SPTS (Single Program Transport Stream) processing module, and a Droidlink module for communication with a particular type of mobile phone. It will be apparent to those of ordinary skill in the art that other modules or other groupings of modules can be provided in the cloudcast subsystem 172.

As also shown in FIG. 2, the platform system 170 can include a headunit subsystem 171, which includes a headunit native human machine interface (HMI) used to convey information and media content to an occupant of a vehicle. For example, the headunit native HMI can include devices or interfaces to devices, such as conventional plasma or liquid crystal display (LCD) monitors, heads-up display devices, projection devices, audio sound systems, and the like. Additionally, the headunit native HMI can include devices or interfaces to devices for receiving input from a user. For example, touch screens, buttons, softkeys, keyboards or key panels, voice command input systems and the like can be coupled with the headunit native HMI of the platform system 170. It will be apparent to those of ordinary skill in the art that various HMI devices can be provided in the platform system 170 of a particular vehicle. As shown in FIG. 2, the headunit native HMI of headunit subsystem 171 can also receive data and media streams from a variety of devices or sources, including audio sources, FM radio sources, Radio Data System (RDS), Digital Audio Broadcasting (DAB), touch panel sources, Hands-Free Profile (HFP), A2DP, and video sources, such as a backup camera in a vehicle. RDS is a communications protocol standard for embedding small amounts of digital information in conventional FM radio broadcasts, Digital Audio Broadcasting, (DAB or DAB+) is a digital radio transmission standard. Hands-Free Profile (HFP) is a Bluetooth profile allowing hands-free kits to communicate with mobile phones in a car. The profile defines how high quality audio (stereo or mono) can he streamed from one device to another over a Bluetooth connection. For example, music can be streamed from a mobile phone to a wireless headset, hearing aid & cochlear implant streamer, car audio, or from as laptop/desktop to a wireless headset. A2DP can be used in conjunction with an intermediate Bluetooth transceiver that connects to a standard audio output jack, encodes the incoming audio to a Bluetooth-friendly format and sends the signal wirelessly to Bluetooth headphones that decode and play the audio. Bluetooth headphones, especially the more advanced models, often come with to microphone and support for the Headset (HSP), Hands-Free (HFP) and Audio/Video Remote Control (AVRCP) profiles. Conventional A2DP is designed to transfer a uni-directional 2-channel stereo audio stream, like music from an MP3 player, to a headset or car radio. Thus, in a variety of ways, the headunit native HMI of the headunit subsystem 171 can receive and render information and media content for an occupant of a vehicle. Similarly, in a variety of ways, the headunit native HMI of the headunit subsystem 171 can receive input and command selections from an occupant of a vehicle. As described above in connection with mapping platform 112, the platform system 170 can also include an event Human Interface Device (HID) mapper. The event HID mapper can map CAN messages to corresponding higher-level events. The higher-level events can trigger communications to other parts of the system, such as via a Bluetooth interface.

Referring still to FIG. 2, the platform system 170 can also include the carlink module 174. The carlink module 174, of an example embodiment, performs a function similar to the abstraction device 122 described above. In particular, the carlink module 174 may include one or more controllers that may be configured to receive one or more data signals from the CAN bus 116. The controller(s) in the carlink module 174 may then communicate the data signals to the cloudcast subsystem 172 and/or other subsystems of the platform system 170. In particular, low-level state changes occurring in vehicle components 118 can be mapped to corresponding higher-level events using the event HID mapper of the headunit subsystem 171 as described above.

As shown in FIG. 2, the data exchanged between the carlink module 174, the cloudcast subsystem 172, the headunit subsystem 171, and the mobile device 106 can be transferred using a Remote Procedure Call (RPC) framework 177. Similarly, the RPC framework 177 of an example embodiment can be used to transfer data between any two inter-process components or subsystems of a data processing system. The RPC framework 177 of an example embodiment, as described in more detail below, provides a low overhead RPC mechanism configured to transfer data and service remote procedure requests in a more efficient manner than conventional RPC systems. Given that many of the state changes occurring in the vehicle components 118 can be represented in one or more data bits, conventional RPC systems require too much system overhead (e.g., excess instructions executed, excess handshake interactions required, excess processor and memory cycles needed, etc.) to convey a single bit (or a few bits) state change between subsystems. As such, the embodiments described herein provide a lower overhead RPC mechanism well-suited, though not exclusively suited, for applications, such as capturing data from and controlling actions of components 118 of a vehicle 104. The embodiments described herein provide a lower overhead RPC mechanism for performing remote procedure calls between subsystems using a reduced amount of data, thereby allowing secure and efficient RPC using minimal communications bandwidth. The details of the low overhead RPC mechanism in an example embodiment are provided herein.

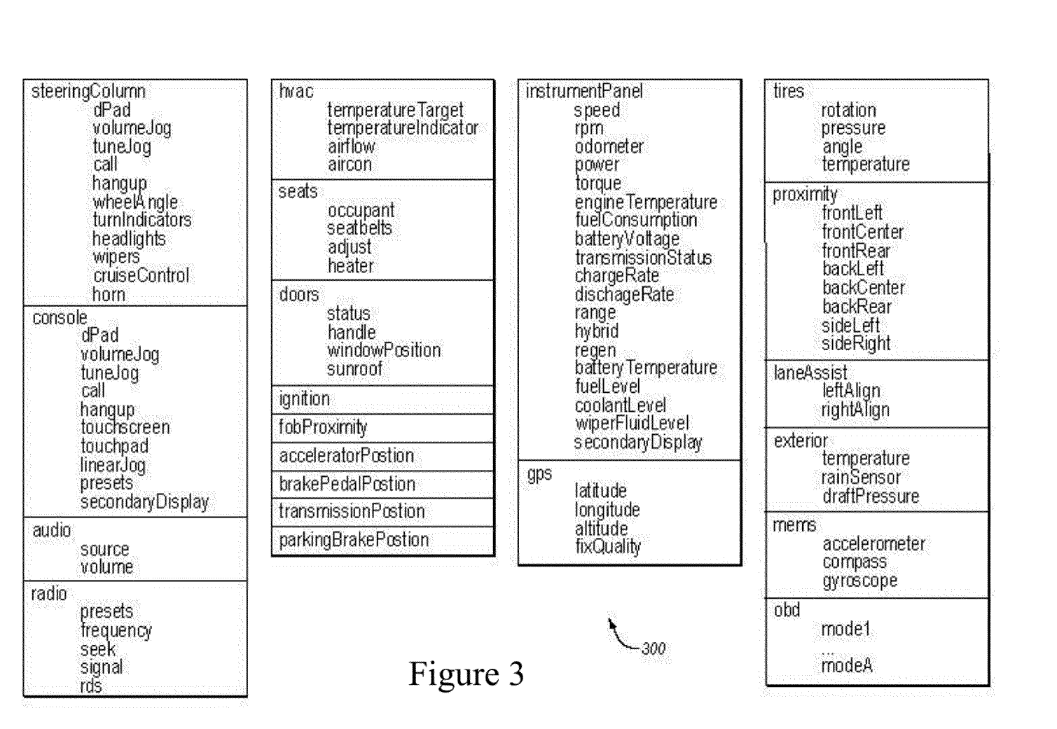

Referring now to FIG. 3, a diagram presents an example of a set of events 300 that can be exposed within the vehicle information and control system 101, wherein the events are determined to have an authentication level that trants access to higher-level events converted by the platform system 170, as opposed to having direct access to raw CAN messages. The set of events 300 depicted in FIG. 3 is just one example of the events that can he exposed within the vehicle information and control system 101. In this example, the set of events 300 can be mapped from corresponding vehicle state change information as described above.

In some embodiments, only a subset of events 300 are exposed within the vehicle information and control system 101 if, for example, certain subsystems or devices are determined to have a more restricted authentication level. In general, the set of events 300 are selected based on the authentication level of the subsystem or device, the ECUs present in a particular vehicle make and model, and the intended purpose and functionality of the subsystems or devices that are to be used within the vehicle information and control system 101 as described herein.

Any of the events in the set of events 300 depicted in FIG. 2 can cause or be caused by an RPC produced by the low overhead RPC mechanism disclosed herein. In many cases, multiple RPC's can be used to service any of the events in the set of events 300. It will be apparent to those of ordinary skill in the art that any events or inter-process processing tasks at any level or layer within the vehicle information and control system 101 can be performed or supported using the low overhead RPC mechanism disclosed herein.

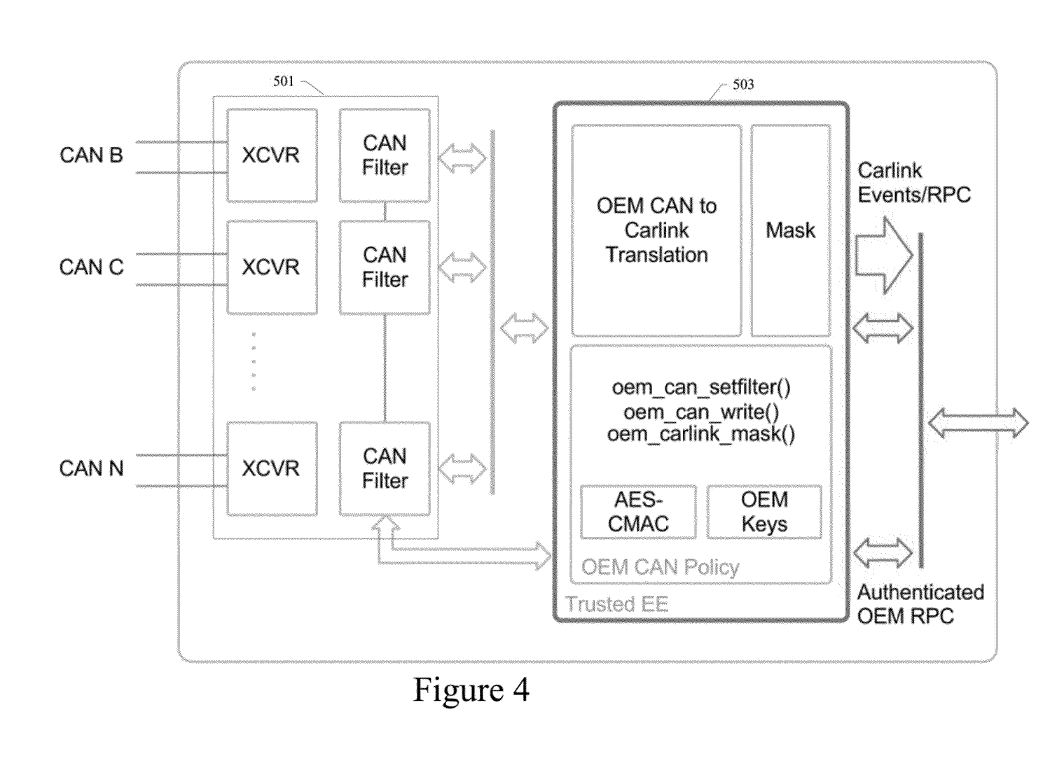

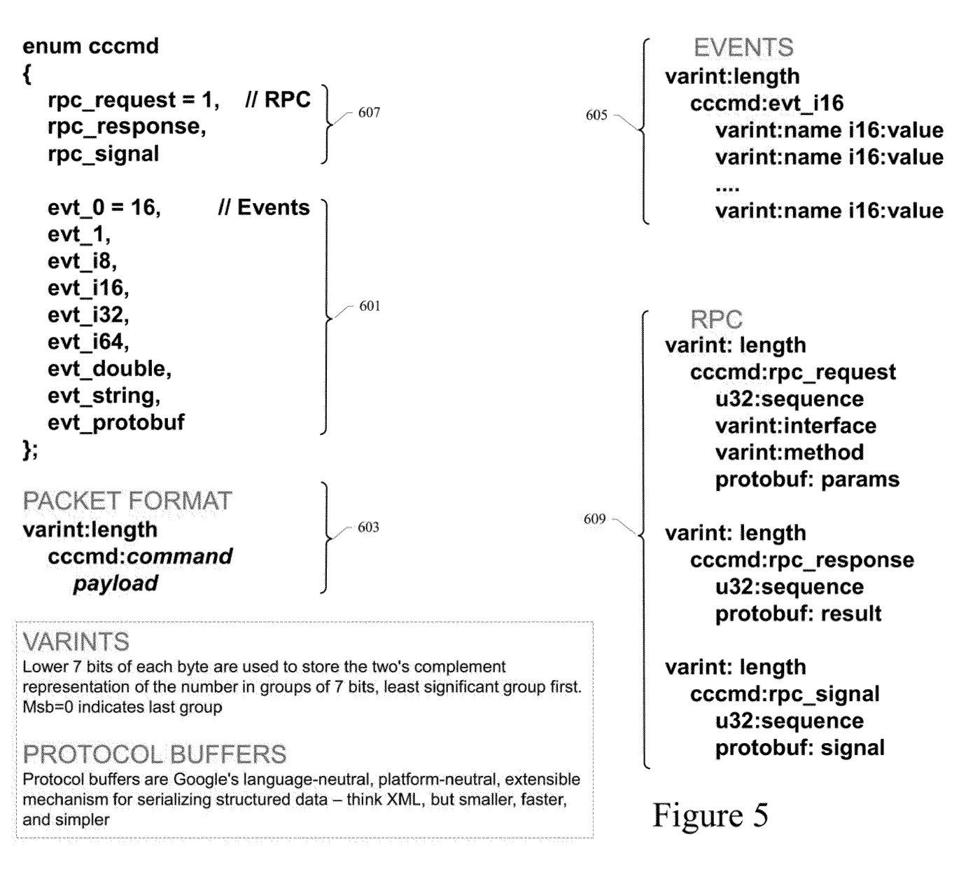

Referring now to FIG. 4, an example illustrates the use of the low overhead RPC mechanism fix communicating a translation of raw CAN data to corresponding events that can be passed up and processed by higher abstraction layers of the vehicle information and control system 101. As described above, the low overhead RPC mechanism of an example embodiment provides a low overhead RPC mechanism configured to transfer data and service remote method or procedure requests in a more efficient manner than conventional RPC systems. State changes occurring in the vehicle components 118 (shown in FIG. 1) can be transferred to a corresponding signal transceiver of CAN transceiver unit 501 shown in FIG. 4. These vehicle state changes can be represented in one or more data bits. Conventional RPC systems require too much system overhead (e.g., excess instructions executed, excess handshake interactions required, excess processor and memory cycles needed, etc.) to convey a single bit (or a few bits) state change between subsystems. In the example embodiment shown in FIG. 4, the vehicle state changes can be transferred from the CAN transceiver unit 501 to event translator 503 via an internal bus. The event translator 503 can be configured to pack the vehicle state change information into the smallest unit of data needed to preserve the vehicle state change information. As described in more detail below, the units of data provided in an example embodiment can range from a single bit to an arbitrarily long data buffer. Additionally, the event translator 503 can he configured to select the best of several available modes for communicating the vehicle state change information to higher-level processes of the vehicle information and control system 101. In an example embodiment, these available modes of communication include: an event transfer mode, an RPC request mode, an RPC response mode, and an RPC signal mode. The data packing and mode selection mechanisms of an example embodiment are described in more detail below in connection with FIG. 5.

Referring now to FIG. 5, the details of the low overhead RPC mechanism of an example embodiment are illustrated. As described above, vehicle state change information can he received by the event translator 503 as a bit string of one or more data bits. Additionally, numeric values, parameters, data sets, and other information can be received from the vehicle components 118 via the CAN transceiver unit 501. The event translator 503 can be configured to select from the available modes of communication including: an event transfer mode, an RPC request mode, an RPC response mode, or an RPC signal mode. For example, the event translator 503 can receive vehicle state change information indicating that a vehicle device has transitioned between a Power-off state and a power-on state. In this case, a single data bit can be used to encode the vehicle state change. In another example, the event translator 503 can receive vehicle state change information indicating, for example, the current speed of the vehicle. The speed of the vehicle might be represented in an eight-hit byte of data. Similarly, other vehicle state change information representing events in the vehicle can he received by the event translator 503. As shown in FIG. 5, the event translator 503 can select any of several available data representations (identified by the command types 601) to pack the vehicle state change information into a small lossless data representation. Additionally, vehicle state change information corresponding to a plurality of vehicle events can be packed together into one or more data representations (identified by the command types 601). In this manner, the vehicle state change information can be tightly and efficiently packed for transfer to other subsystems of the vehicle information and control system 101 in the payload portion of a data packet having a packet format 603 shown in FIG. 5. The data packet can be branded with a command type header 601 that identifies the data representations used for packing the data. An example of the event data packet 605 is shown in FIG. 5. A receiver of the data packet can use the command type header 601 to unpack the payload portion of a data packet and retrieve the data stored therein. As a result, the branded data packet can be efficiently transferred to other subsystems of the vehicle information and control system 101.

The efficient transfer of event information as described above is one component of the low overhead RPC mechanism provided herein. A second component of the low overhead RPC mechanism is a particular RPC structure to support low overhead inter-process request, response, and signaling communications. As shown in FIG. 5, the command type header 607 can brand a data packet as an RPC request, an RPC response, or an RPC signal. As also shown in FIG. 5, the particular structures of these RPC commands are illustrated in the examples 609. For example, the RPC request structure shown in example 609 includes a command type header branding the data packet as an RPC request, a data packet portion for specifying an interface, a data packet portion for specifying a method or procedure to invoke on the remote system, and a data packet portion for defining a buffer for passing parameters for the method or procedure. In this manner, the RPC request structure provides a compact and well-defined RPC data packet that can be transferred to a remote subsystem to issue a request to the remote subsystem. Typically, the RPC request structure can he used when a response from a remote subsystem is expected. It will be apparent to those of ordinary skill in the art that such RPC requests can be sent to any of the subsystems of the vehicle information and control system 101 as described above.

Similarly, the RPC response structure shown in example 609 includes a command type header branding the data packet as an RPC response and a data packet portion for defining a buffer for passing a result from the method or procedure invoked on the remote subsystem in response to a prior request. In this manner, the R PC response structure provides a compact and well-defined RPC data packet that can be transferred from a remote subsystem in response to a prior request to the remote subsystem. It will be apparent to those of ordinary skill in the art that such RPC responses can be sent from any of the subsystems of the vehicle information and control system 101 as described above.

Finally, the RPC signal structure shown in example 609 includes a command type header branding the data packet as an RPC signal and a data packet portion for defining a buffer for passing signaling data to a remote subsystem as part of the signal. In this manner, the RPC signal structure provides a compact and well-defined RPC data packet that can he transferred from one subsystem to another remote subsystem. Typically, the RPC signal structure can be used when a response from a remote subsystem is not expected or needed. It will be apparent to those of ordinary skill in the art that such RPC signals can be sent from any of the subsystems of the vehicle information and control system as described above.

Thus, the low overhead RPC mechanism described herein can support low overhead inter-process event notification, request, response, and signaling communications. Such remote procedure calls between subsystems can use a reduced amount of data, thereby allowing secure and efficient RPC using minimal communications bandwidth.

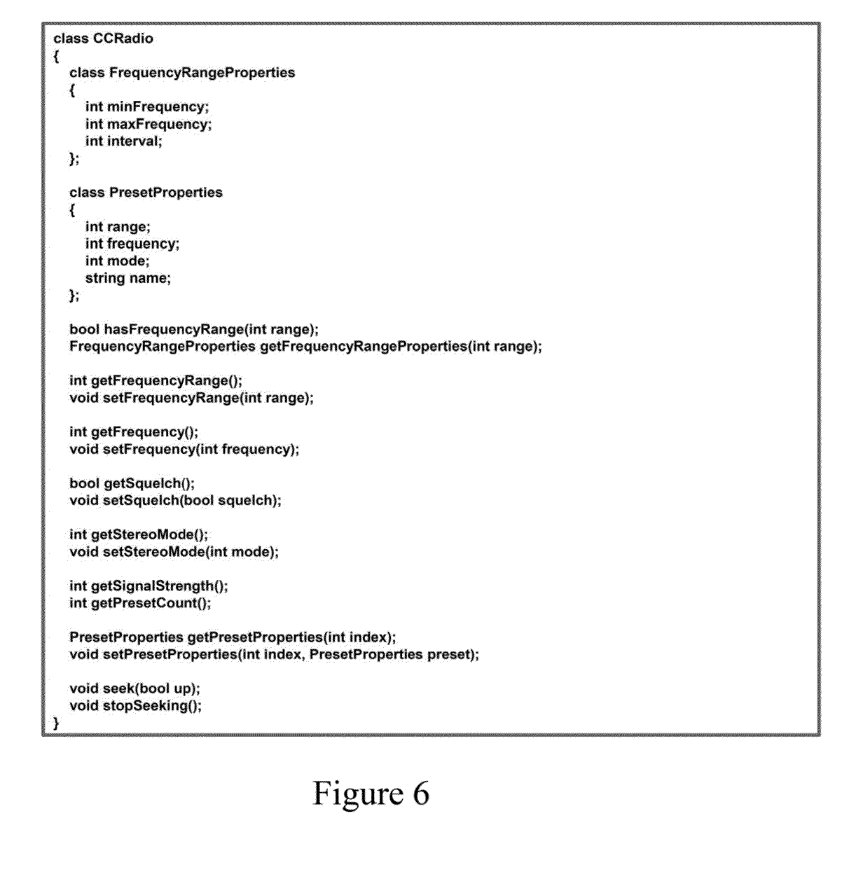

FIG. 6 illustrates an example of the data structures and methods or procedures used to service various events mapped from vehicle state change information passed to the subsystems or the vehicle information and control system 101 as described above. As shown in the example of FIG. 6, a radio in a vehicle can have a variety of events and actions associated therewith. Using the low overhead RPC mechanism described herein, these events and actions can be conveyed to and serviced by the various subsystems of the vehicle information and control system 101 as described herein. As a result, an efficient, sealable, modular, and layered system can be implemented.

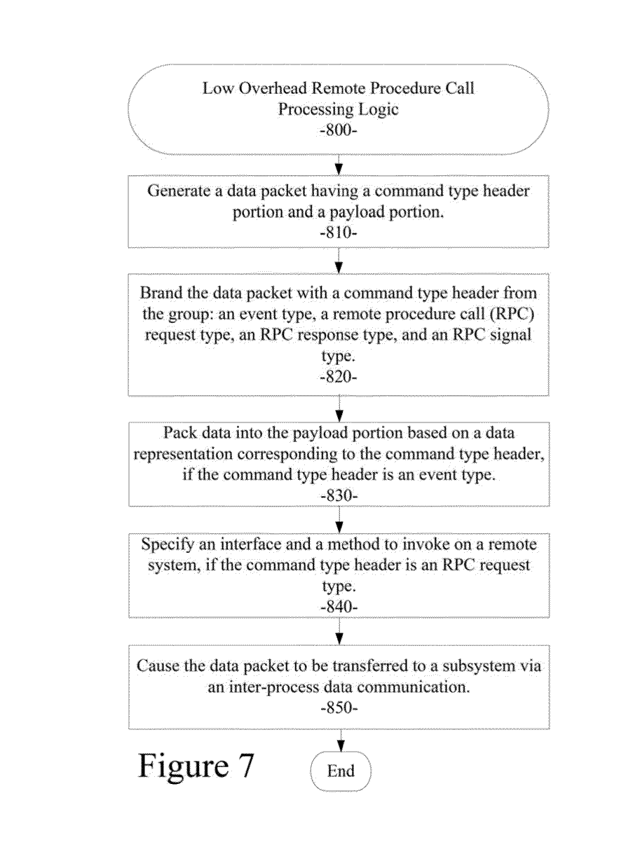

FIG. 7 is a processing flow diagram illustrating an example embodiment of a system and method liar providing low overhead remote procedure calls as described herein. The method of an example embodiment includes: generating, by use of a data processor, a data packet having to command type header portion and a payload portion (processing block 810); branding, by use of the data processor, the data packet with a command type header from the group: an event type, a remote procedure call (RPC) request type, an RPC response type, and an RPC signal type (processing block 820); packing data into the payload portion based on a data representation corresponding to the command type header, if the command type header is an event type (processing block 830); specifying an interface and a method to invoke on a remote system, if the command type header is an RPC request type (processing block 840); and causing the data packet to be transferred to a subsystem via an inter-process data communication (processing block 850).

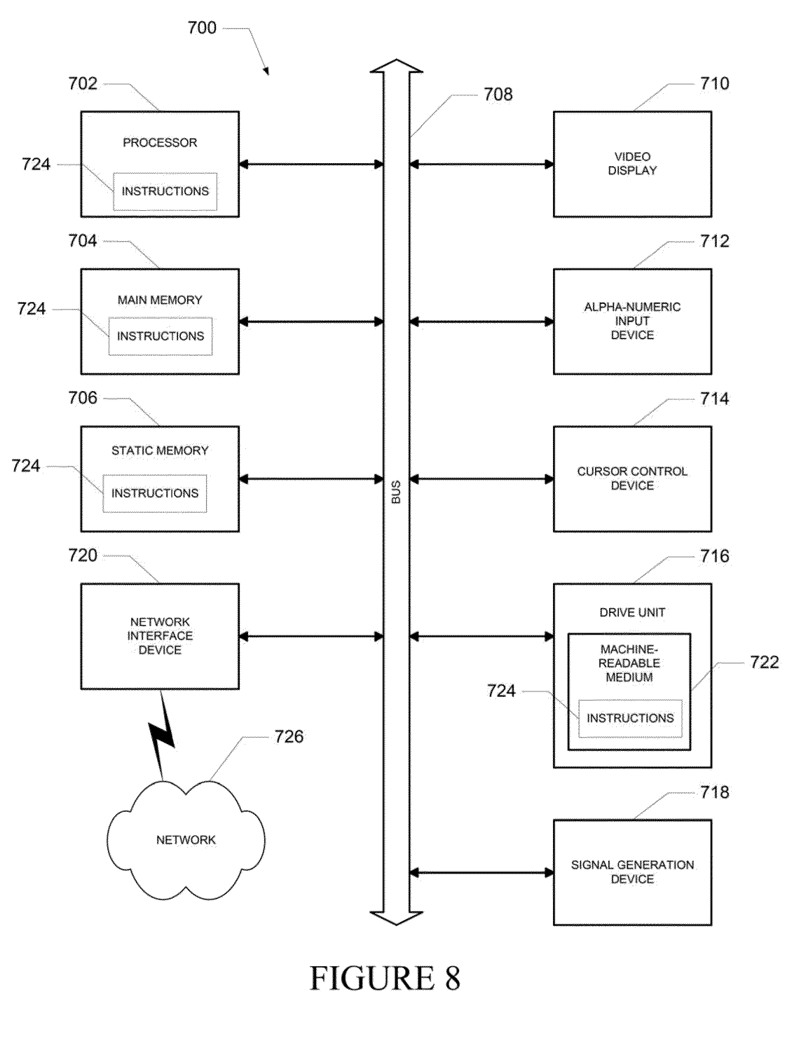

FIG. 8 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. [he machine may be a personal computer (PC), as tablet PC, a set-top box (STB), a Personal Digital Assistant (PDA), a cellular telephone, a web appliance, a network router, switch or bridge, or any machine capable of executing a set of instructions (sequential or otherwise) that specify actions to he taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (CPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should he taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such as set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising;
generating, by use of a data processor, a data packet having a command type header portion and a payload portion;
branding, by use of the data processor, the data packet with a command type header from the group: an event type, a remote procedure call (RPC) request type, an RPC response type, and an RPC signal type;
packing data into the payload portion based on a data representation corresponding to the command type header, if the command type header is an event type;
specifying an interface and a method to invoke on a remote system, if the command type header is an RPC request type; and
causing the data packet to be transferred to a subsystem via an inter-process data communication.

2. The method as claimed in claim 1 including defining a buffer for passing parameters for the method, if the command type header is an RPC request type.

3. The method as claimed in claim 1 including defining a buffer for passing a result, if the command type header is an RPC response type.

4. The method as claimed in claim 1 including defining a buffer for passing signaling data, if the command type header is an RPC signal type.

5. The method as claimed in claim 1 wherein the subsystem is a part of a vehicle information and control system.

6. The method as claimed in claim 1 wherein the data packed into the payload portion includes data corresponding to vehicle state change information.

7. The method as claimed in claim 1 wherein the subsystem is in a different layer of a vehicle information and control system.

8. The method as claimed in claim 1 wherein the subsystem is in a different layer of a vehicle information and control system, at least one layer of the vehicle information and control system substantially mirroring the functionality of the different layer.

9. A system comprising;
one or more data processors; and
a vehicle information and control system, executable by the one or more data processors, to
generate a data packet ha v Mg a command type header portion and a payload portion;
brand the data packet with a command type header from the group an event type, a remote procedure call (RPC) request type, an RPC response type, and an RPC signal type;
pack data into the payload portion based on a data representation corresponding to the command type header, if the command type header is an event type;
specify an interface and a method to invoke on a remote system, if the command type header is an RPC request type; and
cause the data packet to be transferred to a subsystem via an inter-process data communication.

10. The system as claimed in claim 9 being further configured to define a buffer for passing parameters for the method., if the command type header is an RPC request type.

11. The system as claimed in claim 9 being further configured to define a buffer for passing a result, if the command type header is tan RPC response type.

12. The system as claimed in claim 9 being further configured to define a buffer for passing signaling data, if the command type header is an RPC signal type.

13. The system as claimed in claim 9 wherein the subsystem is a part of a vehicle information and control system.

14. The system as claimed in claim 9 wherein the data packed into the payload portion includes data corresponding to vehicle state change information.

15. A non-transitory machine-useable storage medium embodying instructions which, when executed by a machine, cause the machine to:
generate a data packet having a command type header portion and a payload portion;
brand the data packet with a command type header from the group: an event type, a remote procedure call (RPC) request type, an RPC response type, and an RPC signal type;
pack data into the payload portion had on a data representation corresponding to the command type header, if the command type header is an event type;
specify an interface and a method to invoke on as remote system, if the command type header is an RPC request type; and
cause the data packet to be transferred to a subsystem is an inter-process data communication.

16. The machine-useable storage medium as claimed in claim 15 being further configured to define a buffer for passing parameters for the method, if the command type header is an RPC request type.

17. The machine-useable storage medium as claimed in claim 15 being further configured to define a buffer for passing a result, if the command type header is an RPC response type.

18. The machine-useable storage medium as claimed in claim 15 being further configured to define a buffer for passing signaling data, if the command type header is an RPC signal type.

19. The machine-useable storage medium as claimed in claim 15 wherein the subsystem is a at of a vehicle information and control system.

20. The machine-useable storage medium as claimed in claim 15 wherein the data packed into the payload portion includes data corresponding to vehicle state change information.
